(19) United States
(12) Patent Application Publication
(10) Pub. No.: US 2020/0231000 A1
(43) Pub. Date: Jul. 23, 2020

(54) LUG STUD PROTECTOR AND SYSTEM INCLUDING SAME

(71) Applicant: Hutchinson Industries, Inc., Trenton, NJ (US)

(72) Inventors: Christopher R. RENSON, Langhorne, PA (US); Paul ARDOVINI, West Seneca, NY (US)

(21) Appl. No.: 16/749,591

(22) Filed: Jan. 22, 2020

Related U.S. Application Data
(60) Provisional application No. 62/795,216, filed on Jan. 22, 2019.

(51) Int. Cl. B60B 7/06; B60B 7/02

(52) U.S. Cl. CPC B60B 7/068; B60B 7/02

(57) ABSTRACT

A system is disclosed. The system includes a lug stud protector and a tire shield. The lug stud protector includes a body portion and a flange portion, and is configured to protect lug studs and corresponding lug nuts which connect a wheel to a hub of a vehicle. The tire shield is removably connected to the lug stud protector.

### CROSS-REFERENCE TO RELATED APPLICATION

This application claims the benefit under 35 U.S.C. § 119(e) of the earlier filing date of U.S. Provisional Patent Application No. 62/795,216 filed on Jan. 22, 2019, titled LUG STUD PROTECTOR AND SYSTEM INCLUDING SAME, the contents of which are hereby incorporated by reference in their entirety.

### BACKGROUND

This application discloses an invention which is related, generally and in various aspects, to a lug stud protector and a system including the same.

Single-piece wheels and multi-piece wheels utilized with vehicles are known in the art. For a given vehicle, such wheels are connected to a hub of the vehicle with lug studs and lug nuts. The lug studs are connected to the hub of the vehicle, pass through openings of the wheel, and have lug nuts threaded onto the lug studs to secure the wheel to the hub of the vehicle.

A concern with any wheel such as the wheels described above is that because the lug studs extend axially outward past a transverse wall of the wheel, the lug studs and the lug bolts are exposed to environments and objects proximate to the wheel, and are thus unprotected from objects which can come into contact with the lug studs and/or the lug nuts. Depending on a variety of factors such as the speed of the vehicle associated with the wheel, the speed (if any) the object is approaching the lug studs and the lug nuts, the orientation of the object relative to the lug studs and the lug nuts, the mass of the object, the composition of the object, etc., the lug studs and the lug nuts can be damaged, sometimes severely to the point of failure, when an object comes into contact with the lug studs and/or the lug nuts.

It is desirable to protect the lug studs and the lug nuts which connect the wheel to the hub of the vehicle with a protector, and it is also desirable to utilize the protector as a mounting point for a tire shield.

### BRIEF DESCRIPTION OF THE DRAWINGS

The novel features of the aspects described herein are set forth with particularity in the appended claims. The aspects, however, both as to organization and methods of operation may be better understood by reference to the following description, taken in conjunction with the accompanying drawings.

FIG. 1 illustrates a cross-section of a system which includes a lug stud protector, in accordance with at least one aspect of the present disclosure;

FIG. 2 illustrates a partial cross-section of the system of FIG. 1, in accordance with at least one aspect of the present disclosure;

FIG. 3 illustrates a partial exploded view of the system of FIG. 1, in accordance with at least one aspect of the present disclosure;

FIG. 4 illustrates another partial exploded view of the system of FIG. 1, in accordance with at least one aspect of the present disclosure;

FIG. 5 illustrates a cross-section of a system which includes a lug stud protector and a tire shield mounting adapter, in accordance with at least one aspect of the present disclosure;

FIG. 6 illustrates a partial cross-section of the system of FIG. 5, in accordance with at least one aspect of the present disclosure.

FIG. 7 illustrates a partial exploded view of the system of FIG. 5, in accordance with at least one aspect of the present disclosure; and

FIG. 8 illustrates another partial exploded view of the system of FIG. 5, in accordance with at least one aspect of the present disclosure.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

In the following detailed description, reference is made to the accompanying drawings, which form a part hereof. In the drawings, similar symbols and reference characters typically identify similar components throughout several views, unless context dictates otherwise. The illustrative aspects described in the detailed description, drawings and claims are not meant to be limiting. Other aspects may be utilized, and other changes may be made, without departing from the scope of the technology described herein.

The following description of certain examples of the technology should not be used to limit its scope. Other examples, features, aspects, embodiments and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, aspects, embodiments, examples, etc. described herein may be combined with any one or more of the other teachings, expressions, aspects, embodiments, examples, etc. that are described herein. The following described teachings, expressions, aspects, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Before explaining the various aspects of the lug stud protector and the system in detail, it should be noted that the various aspects disclosed herein are not limited in their application or use to the details of construction and arrangement of parts illustrated in the accompanying drawings and description. Rather, the disclosed aspects may be positioned or incorporated in other aspects, embodiments, variations and modifications thereof, and may be practiced or carried out in various ways. Accordingly, aspects of the lug stud protector and the system disclosed herein are illustrative in nature and are not meant to limit the scope or application thereof. Furthermore, unless otherwise indicated, the terms and expressions employed herein have been chosen for the purpose of describing the aspects for the convenience of the reader and are not meant to limit the scope thereof. In addition, it should be understood that any one or more of the disclosed aspects, expressions of aspects, and/or examples thereof, can be combined with any one or more of the other disclosed aspects, expressions of aspects, and/or examples thereof, without limitation.

Also, in the following description, it is to be understood that terms such as inward, outward, upward, downward, above, below, left, right, interior, exterior, axially, radially and the like are words of convenience and are not to be construed as limiting terms. Terminology used herein is not meant to be limiting insofar as devices described herein, or portions thereof, may be attached or utilized in other orientations. The various aspects will be described in more detail with reference to the drawings.

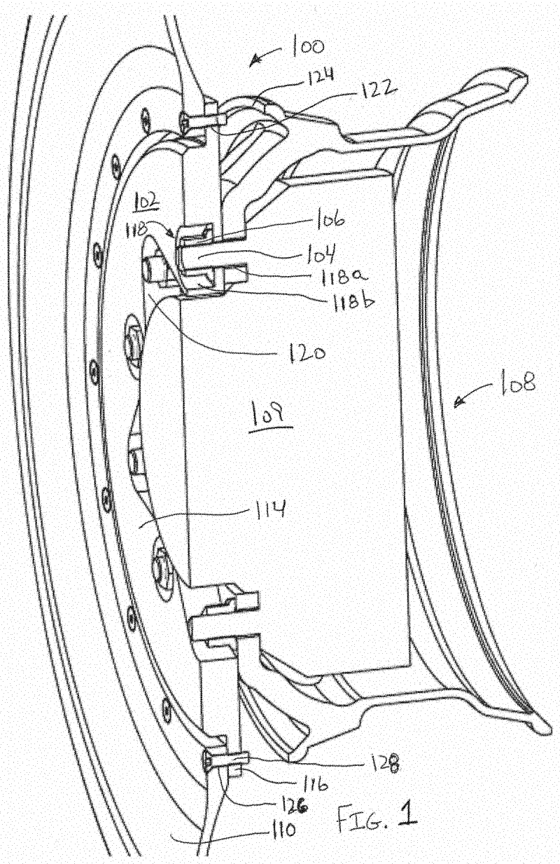

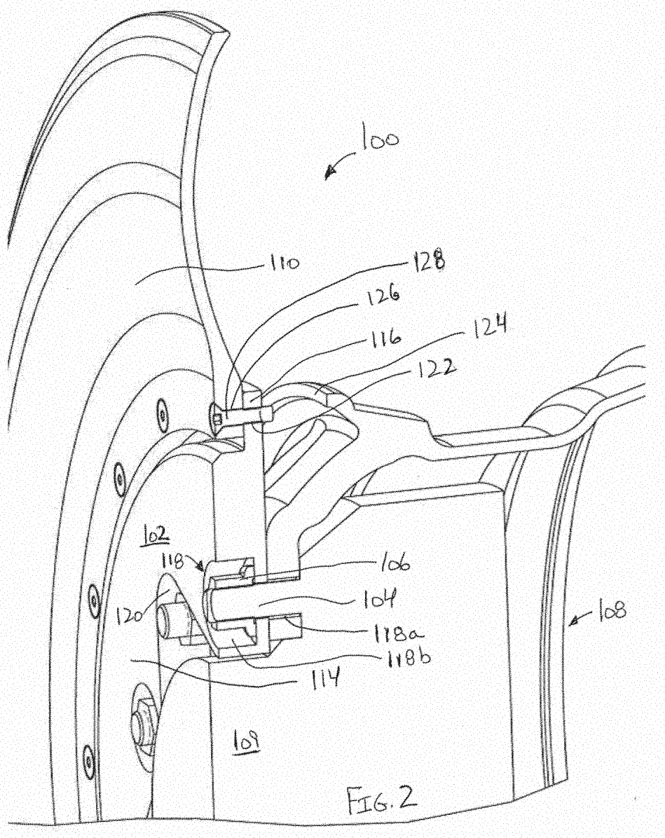

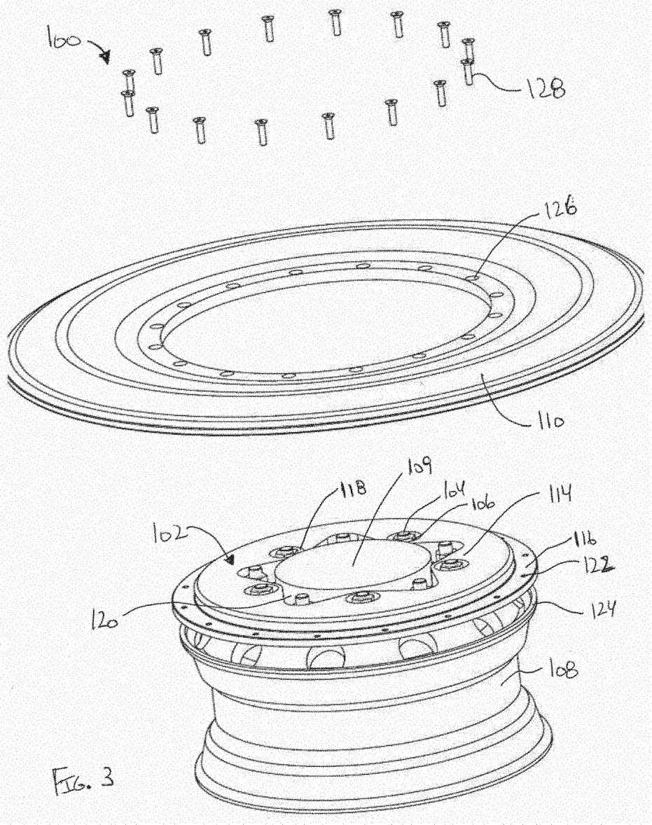

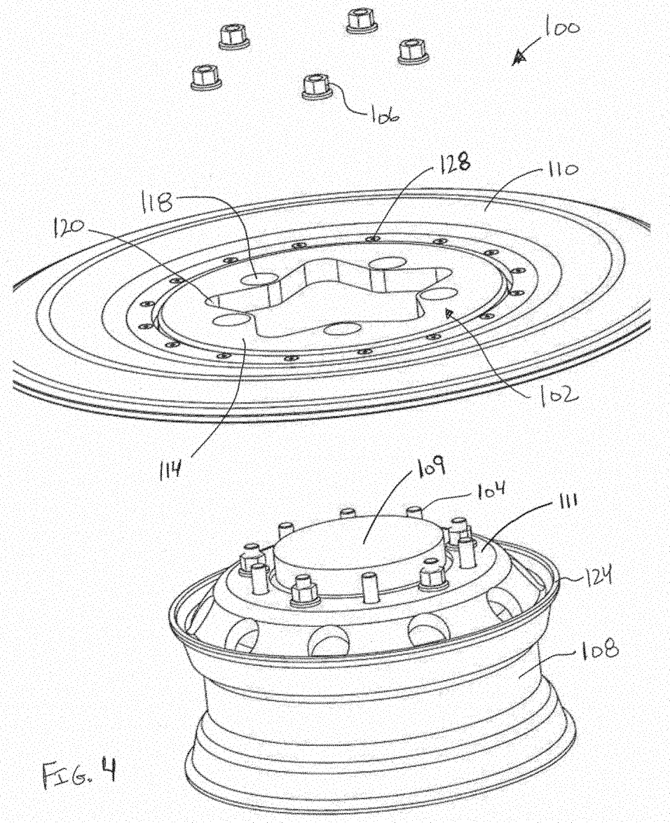

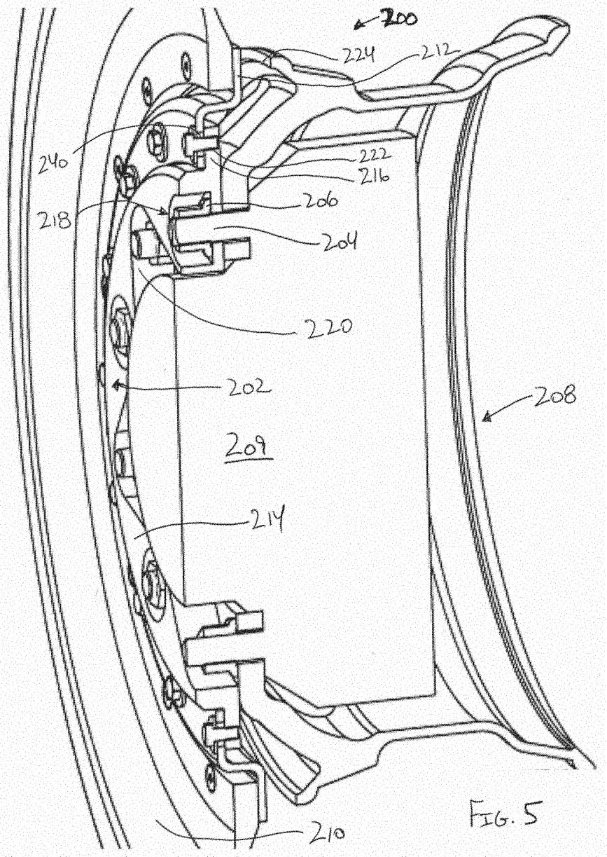

FIGS. 1-4 illustrate a system 100 which includes a lug stud protector 102, in accordance with at least one aspect of the present disclosure. As described in more detail below, the lug stud protector 102 can be utilized to protect lug studs 104 and lug nuts 106 from damage, where the lug studs 104 and the lug nuts 106 are utilized to connect a wheel 108 to a hub 109 of a vehicle. For purposes of clarity, the vehicle is not shown. The lug stud protector 102 can also be utilized to serve as a mounting point for a tire shield 110 which protects a sidewall of a tire mounted to the wheel 108 from damage or as a mounting point for a tire shield mounting adapter 212 (See FIGS. 5-8) which serves as an alternative mounting point for the tire shield 110. FIG. 1 is a cross-section of the system 100 which includes the lug stud protector 102, FIG. 2 is a partial cross-section of the system 100, FIG. 3 is a partial exploded view of the system 100 (showing the lug stud protector 102 connected to the wheel 108), and FIG. 4 is another partial exploded view of the system 100 (showing the tire shield 110 mounted to the lug stud protector 102). The wheel 108 may be a single-piece wheel or a multi-piece wheel, and may have a tubeless tire mounted thereon. For purposes of simplicity the tubeless tire is not shown in FIGS. 1-4.

According to various aspects, the system 100 also includes the tire shield 110. According to various aspects, the system 100 further includes the wheel 108, the lug studs 104 and the corresponding lug nuts 106 which connect the wheel 108 to the hub 109 of a vehicle, and may also include a tire (not shown) mounted on the wheel 108. For ease of description purposes, the lug studs 104 and the corresponding lug nuts 106 are described below as including first and second sets of lug studs 104 and corresponding lug nuts 106.

The lug stud protector 102 is removably connected to the wheel 108 with the first set of the lug studs 104 and the corresponding lug nuts 106. The first set of the lug studs 104 and the corresponding lug nuts 106 may include any number of the lug studs 104 and the corresponding lug nuts 106. For example, according to various aspects, the first set includes five of the lug studs 104 and the corresponding lug nuts 106 as shown in FIG. 3.

The lug stud protector 102 is ring-shaped and includes a body portion 114 and a flange portion 116. The body portion 114 is radially inward from the flange portion 116 (relative to an axis of rotation of the wheel 108), is thicker than the flange portion 116 (in the axial direction) and defines openings 118 therethrough. According to various aspects, the body portion 114 also includes scallops and/or cut-out portions 120.

For the openings 118 corresponding to the first set of the lug studs 104 and the lug nuts 106, each of the openings 118 includes a first portion 118a and a second portion 118b. The openings 118 corresponding to the first set of the lug studs 104 and the lug nuts 106 are counterbored such that the first portions 118a have a first diameter and the second portions 118b have a second diameter, where the second diameter is greater than the first diameter. The first portions 118a are axially inboard from the corresponding second portions 118b. The first portions 118a of the openings 118 corresponding to the first set of the lug studs 104 and the lug nuts 106 are sized to pass over and surround the first set of the lug studs 104. The second diameter is large enough to allow the first set of the lug nuts 106 to be threaded onto the corresponding lug studs 104 and tightened against the “bottoms” of the second portions 118b of the openings 118 to secure the lug stud protector 102 to the wheel 108.

Although not shown in FIGS. 1-4, according to various aspects, the body portion 114 also includes additional openings 118 (not shown) therethrough which correspond to the second set of lug studs 104 and the corresponding lug nuts 106. The additional openings 118 are uniform in that the entirety of the additional openings 118 have the second diameter to allow for the lug stud protector 102 to pass over and surround the second set of the lug studs 104 and the corresponding lug nuts 106.

In lieu of the additional openings 118, according to various aspects the body portion 114 includes scallops and/or cut-outs 120. The cut-outs 120 correspond to the second set of the lug studs 104 and the corresponding lug nuts 106, partially surround the second set of the lug studs 104 and the corresponding lug nuts 106, and are configured to allow the lug stud protector 102 to pass over and partially surround the second set of lug studs 104 when the lug stud protector 102 is connected to the wheel 108, without having to first remove any of the second set of lug nuts 106. This configuration allows for the overall weight of the lug stud protector 102 to be reduced while still providing protection for all of the lug studs 104 and corresponding lug nuts 106 from damage. Additionally, this configuration allows the lug stud protector to be installed without having to remove every one of the lug nuts 106, thereby avoiding the need to lift the vehicle off the ground to mount the lug stud protector 102 to the wheel 108.

According to various aspects, the thickness of the body portion 114 of the lug stud protector 102 proximate the lug studs 104 and the corresponding lug nuts 106 is such that when the lug stud protector 102 is connected to the wheel 108 and the wheel 108 is connected to the hub 109 of the vehicle, the body portion 114 extends axially outward at least as far as, or further than, a length which the lug studs 104 project axially outward from a transverse wall 111 (See FIG. 4) of the wheel 108. This minimizes the likelihood of objects coming into contact with the lug studs 104 and/or the corresponding lug nuts 106 and thus mitigates any potential damage resulting from such contact. According to other aspects, the thickness of the body portion 114 of the lug stud protector 102 proximate the lug studs 104 and the corresponding lug nuts 106 is such that when the lug stud protector 102 is connected to the wheel 108 and the wheel is connected to the hub 109 of the vehicle, the body portion 114 extends axially outward less (e.g., slightly less) than the lug studs 104 do.

The flange portion 116 is radially outward from the body portion 114 of the lug stud protector 102, is thinner than the body portion 114 (in the axial direction), defines threaded openings 122 therethrough, and serves as a mounting point for the tire shield 110. According to various aspects, the flange portion 116 extends radially outward to a position which approximates the position of a flange portion 124 of the wheel 108. Although the lug stud protector 102 is shown as a single piece in FIGS. 3 and 4, it will be appreciated that according to other aspects, the lug stud protector 102 can include a plurality of segments (e.g., two or three) which collectively form the ring-shape.

The tire shield 110 is configured to protect the sidewall of a tire mounted to the wheel 108 from damage caused by foreign objects. According to various aspects, the tire shield 110 covers a majority of a sidewall of the tire, has an outboard side which is convex and an inboard side which is concave. Tire shields such as tire shield 110 are described in more detail, for example, in U.S. Pat. No. 9,895,927, the entire content of which is hereby incorporated by reference. The tire shield 110 includes a plurality of openings 126 which correspond to the threaded openings 122 of the flange portion 116 of the lug stud protector 102, and is removably connected to the lug stud protector 102 by a plurality of fasteners 128 which pass through openings 126 in the tire shield 110 and are threadedly engaged with the threaded openings 122 of the flange portion 116 of the lug stud protector 102. Thus, it will be appreciated that the tire shield 110 is removably connected to the lug stud protector 102, and can be removed and replaced without having to remove the lug stud protector 102 from the wheel 108 (See FIG. 3). Alternatively, as the tire shield 110 is connected to the lug stud protector 102, removing the lug stud protector 102 from the wheel 108 also removes the tire shield 110 from the wheel 108 (See FIG. 4).

In many instances, it is feasible for the lug stud protector 102 to correspond to the size and configuration of the wheel 108, thereby allowing the tire shield 110 to be connected directly to the lug stud protector 102 as shown for example in FIGS. 1-2 and 4. However, in certain instances, the size and/or configuration of the wheel 108 makes it more feasible to utilize a tire shield mounting adapter to connect the tire shield 110 to the lug stud protector 102.

FIGS. 5-8 illustrate a system 200 which includes a lug stud protector 202 and a tire shield mounting adapter 212, in accordance with at least one aspect of the present disclosure. The lug stud protector 202 may be similar or identical to the lug stud protector 102, can be utilized to protect lug studs 204 and corresponding lug nuts 206 from damage (where the lug studs 204 and the lug nuts 206 are utilized to connect a wheel 208 to a hub 209 of a vehicle), and can serve as a mounting point for a tire shield 210. For purposes of clarity, the vehicle is not shown. The wheel 208 may be similar or identical to the wheel 108 (it can be a single-piece wheel or a multi-piece wheel), and may have a tubeless tire mounted thereon as described above. For purposes of simplicity the tubeless tire is not shown in FIGS. 5-8. The tire shield 210 may be similar or identical to the tire shield 110.

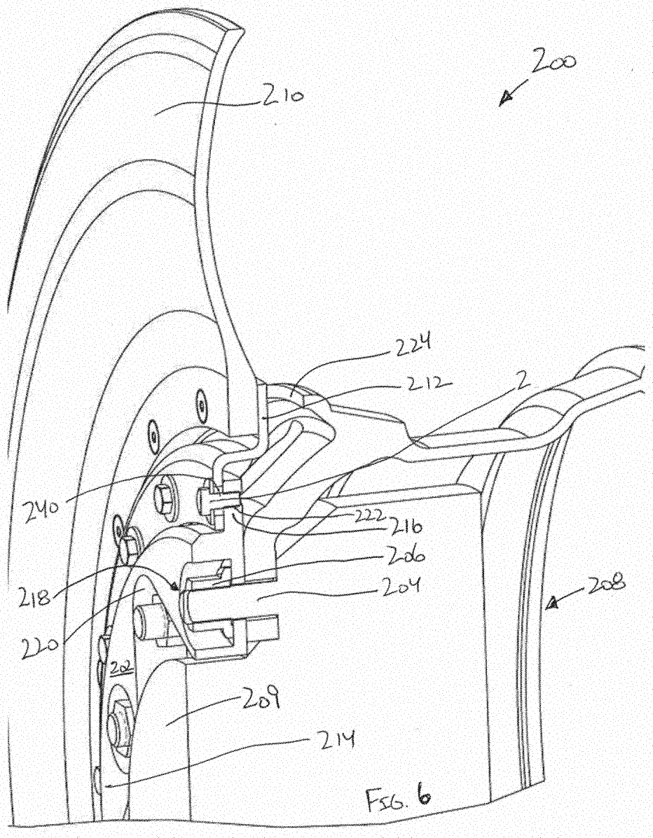

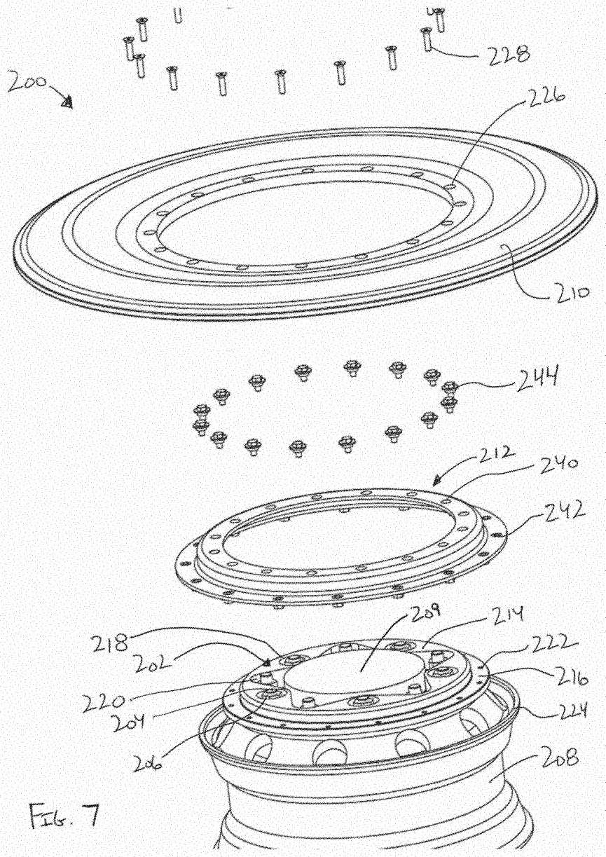

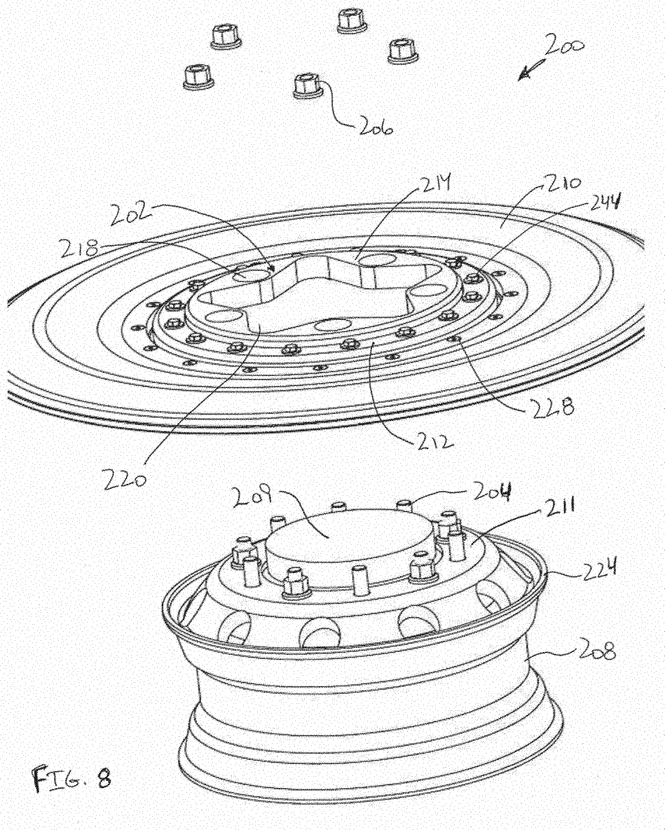

The system 200 is similar to the system 100, but is different in that the system 200 includes the tire shield mounting adapter 212, and the tire shield 210 is removably connected to the tire shield mounting adapter 212 (instead of to the lug stud protector 202 as in the system 100). FIG. 5 is a cross-section of the system 200 which includes the lug stud protector 202 and the tire shield mounting adapter 212, FIG. 6 is a partial cross-section of the system 200, FIG. 7 is a partial exploded view of the system 200 (showing the lug stud protector 202 connected to the wheel 208), and FIG. 8 is another partial exploded view of the system 200 (showing the tire shield 210 connected to a tire shield mounting adapter 212 which is connected to the lug stud protector 202).

According to various aspects, the system 200 also includes the tire shield 210. According to various aspects, the system 200 further includes the wheel 208, the lug studs 204 and the corresponding lug nuts 206 which connect the wheel 208 to the hub 209 of the vehicle, and may also include a tire (not shown) mounted on the wheel 208. For ease of description purposes, the lug studs 204 and the corresponding lug nuts 206 are described below as including first and second sets of lug studs 204 and corresponding lug nuts 206.

As indicated above, the lug stud protector 202 may be similar or identical to the lug stud protector 102. Thus, the lug stud protector 202 is removably connected to the wheel 208 (when the wheel 208 is connected to the hub 209 of the vehicle) with the first set of the lug studs 204 and the corresponding lug nuts 206, is ring-shaped and includes a body portion 214 and a flange portion 216 (which are similar or identical to the body portion 114 and the flange portion 116), defines openings 218 therethrough (which are similar or identical to the openings 118), and also includes scallops and/or cut-out portions 220 (which are similar or identical to the cut-out portions 120). However, as shown in FIG. 6, for this aspect, all of the lug stud protector 202 is positioned radially inward from the flange portion 224 of the wheel 208.

According to various aspects, the thickness of the body portion 214 of the lug stud protector 202 proximate the lug studs 204 and the corresponding lug nuts 206 is such that when the lug stud protector 202 is connected to the wheel 208 and the wheel 208 is connected to the hub 209 of the vehicle, the body portion 214 extends axially outward at least as far as, or further than, a length which the lug studs 204 project axially outward from a transverse wall 211 (See FIG. 8) of the wheel 208. This minimizes the likelihood of objects coming into contact with the lug studs 204 and/or the corresponding lug nuts 206 and thus mitigates any potential damage resulting from such contact. According to other aspects, the thickness of the body portion 214 of the lug stud protector 202 proximate the lug studs 204 and the corresponding lug nuts 206 is such that when the lug stud protector 202 is connected to the wheel 208 and the wheel 208 is connected to the hub 209 of the vehicle, the body portion 214 extends axially outward less (e.g., slightly less) than the lug studs 204 do.

The tire shield mounting adapter 212 is ring-shaped, extends radially outward from the lug stud protector 202 to a position proximate the flange portion 224 of the wheel 208, includes a first plurality of openings 240 which correspond to the threaded openings 222 of the flange portion 216 of the lug stud protector 202, and a second plurality of openings 242 (See FIG. 7) which are threaded openings. The tire shield mounting adapter 212 may be of any suitable shape or configuration. For example, as shown in FIG. 5, one portion of the tire shield mounting adapter 212 (e.g., the portion which includes the openings 240) can be axially outward from another portion of the tire shield mounting adapter 212 (e.g., the portion which includes the openings 242). The tire shield mounting adapter 212 is removably connected to the lug stud protector 202 with fasteners 244 which pass through the openings 240 of the tire shield mounting adapter 212 and threadingly engage with the threaded openings 222 of the flange portion 216 of the lug stud protector 202. Although the tire shield mounting adapter 212 is shown as a single piece in FIGS. 7 and 8, it will be appreciated that according to other aspects, the tire shield mounting adapter 212 can include a plurality of segments (e.g., two or three) which collectively form the ring-shape.

The tire shield 210 is similar or identical to the tire shield 110 in that the tire shield 210 is configured to protect the sidewall of a tire mounted to the wheel 208 from damage caused by foreign objects, covers a majority of a sidewall of the tire, has an outboard side which is convex and an inboard side which is concave, and includes a plurality of openings 226. However, the tire shield 210 is removably connected to the tire shield mounting adapter 212 by a plurality of fasteners 228 which pass through openings 226 in the tire shield 210 and are threadedly engaged with the threaded openings 242 of the tire shield mounting adapter 212.

As the tire shield 210 is removably connected to the tire shield mounting adapter 212, it will be appreciated that the tire shield 210 can be removed and replaced without having to remove the tire shield mounting adapter 212 from the lug stud protector 202 and/or without having to remove the lug stud protector 202 from the wheel 208 (See FIG. 7). Alternatively, as the tire shield 210 is removably connected to the tire shield mounting adapter 212, which is removably connected to the lug stud protector 202, removing the tire shield mounting adapter 212 from the lug stud protector 202 and/or removing the lug stud protector 202 from the wheel 208 also removes the tire shield 210 from the wheel 208 (See FIG. 8).

### EXAMPLES

### Example 1

A system is provided. The system comprises a lug stud protector and a tire shield. The lug stud protector comprises a body portion and a flange portion, and is configured to protect lug studs and corresponding lug nuts which connect a wheel to a hub of a vehicle. The tire shield is removably connected to the lug stud protector.

### Example 2

The system of Example 1, wherein the body portion of the lug stud protector defines counterbored openings, and at least one of the openings comprises (1) a first portion which defines a first diameter and (2) a second portion which defines a second diameter, wherein the second diameter is greater than the first diameter.

### Example 3

The system of Example 2, wherein (1) the first diameter is greater than a diameter of a first one of the lug studs and is smaller than a diameter of a first one of the corresponding lug nuts and (2) the second diameter is greater than the diameter of the first one of the corresponding lug nuts.

### Example 4

The system of Examples 1, 2 or 3, wherein the body portion of the lug stud protector defines cut-outs, wherein a first one of the cut-outs partially surrounds a first one of the lug studs and a first one of the corresponding lug nuts.

### Example 5

The system of Examples 1, 2, 3 or 4, wherein the body portion of the lug stud protector is radially inward from the flange portion of the lug stud protector.

### Example 6

The system of Examples 1, 2, 3, 4 or 5, wherein the body portion of the lug stud protector comprises a thickness which is greater than a thickness of the flange portion of the lug stud protector.

### Example 7

The system of Examples 1, 2, 3, 4, 5 or 6, wherein the body portion of the lug stud protector comprises a thickness which is greater than a length which the lug studs project axially outward from a transverse wall of the wheel when the wheel is connected to the hub of the vehicle.

### Example 8

The system of Examples 1, 2, 3, 4, 5, 6 or 7, wherein the flange portion of the lug stud protector comprises a plurality of threaded openings.

### Example 9

The system of Examples 1, 2, 3, 4, 5, 6, 7 or 8, wherein the tire shield is removably connected to the flange portion of the lug stud protector.

### Example 10

The system of Examples 1, 2, 3, 4, 5, 6, 7, 8 or 9, further comprising the wheel.

### Example 11

The system of Example 10, further comprising a tire mounted on the wheel.

### Example 12

A system is provided. The system comprises a lug stud protector, a tire shield mounting adapter and a tire shield. The lug stud protector comprises a body portion and a flange portion, and is configured to protect lug studs and corresponding lug nuts which connect a wheel to a hub of a vehicle. The tire shield mounting adapter is removably connected to the lug stud protector. The tire shield is removably connected to the tire shield mounting adapter.

### Example 13

The system of Example 12, wherein the body portion of the lug stud protector defines cut-outs, wherein a first one of the cut-outs partially surrounds a first one of the lug studs and a first one of the corresponding lug nuts.

### Example 14

The system of Examples 12 or 13, wherein the body portion of the lug stud protector is radially inward from the flange portion of the lug stud protector.

### Example 15

The system of Examples 12, 13 or 14, wherein the body portion of the lug stud protector comprises a thickness which is greater than a thickness of the flange portion of the lug stud protector.

### Example 16

The system of Examples 12, 13, 14 or 15, wherein the body portion of the lug stud protector comprises a thickness which is greater than a length which the lug studs project axially outward from a transverse wall of the wheel when the wheel is connected to the hub of the vehicle.

### Example 17

The system of Examples 12, 13, 14, 15 or 16, wherein the flange portion of the lug stud protector comprises a plurality of threaded openings.

### Example 18

The system of Examples 12, 13, 14, 15, 16 or 17, wherein the tire shield mounting adapter defines a first plurality of openings and a second plurality of openings.

### Example 19

The system of Example 18, wherein the second plurality of openings comprise threaded openings.

### Example 20

The system of Examples 12, 13, 14, 15, 16, 17, 18 or 19, wherein the tire shield mounting adapter extends radially outward from the lug stud protector.

### Example 21

The system of Examples 12, 13, 14, 15, 16, 17, 18, 19 or 20, further comprising the wheel.

### Example 22

The system of Example 21, further comprising a tire mounted on the wheel.

Although the various aspects of the lug stud protector and the system have been described herein in connection with certain disclosed aspects, many modifications and variations to those aspects may be implemented. Also, where materials are disclosed for certain components, other materials may be used. Furthermore, according to various aspects, a single component may be replaced by multiple components, and multiple components may be replaced by a single component, to perform a given function or functions. The foregoing description and the appended claims are intended to cover all such modifications and variations as falling within the scope of the disclosed aspects.

While this invention has been described as having exemplary designs, the described invention may be further modified within the spirit and scope of the disclosure. This application is therefore intended to cover any variations, uses, or adaptations of the invention using its general principles.

Any patent, patent application, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system, comprising:
a lug stud protector comprising a body portion and a flange portion, wherein the lug stud protector is configured to protect lug studs and corresponding lug nuts which connect a wheel to a hub of a vehicle; and
a tire shield removably connected to the lug stud protector.

2. The system of claim 1, wherein the body portion of the lug stud protector defines counterbored openings, wherein at least one of the openings comprises:
a first portion which defines a first diameter; and
a second portion which defines a second diameter, wherein the second diameter is greater than the first diameter.

3. The system of claim 2, wherein:
the first diameter is greater than a diameter of a first one of the lug studs and is smaller than a diameter of a first one of the corresponding lug nuts; and
the second diameter is greater than the diameter of the first one of the corresponding lug nuts.

4. The system of claim 1, wherein the body portion of the lug stud protector defines cut-outs, wherein a first one of the cut-outs partially surrounds a first one of the lug studs and a first one of the corresponding lug nuts.

5. The system of claim 1, wherein the body portion of the lug stud protector is radially inward from the flange portion of the lug stud protector.

6. The system of claim 1, wherein the body portion of the lug stud protector comprises a thickness which is greater than a thickness of the flange portion of the lug stud protector.

7. The system of claim 1, wherein the body portion of the lug stud protector comprises a thickness which is greater than a length which the lug studs project axially outward from a transverse wall of the wheel when the wheel is connected to the hub of the vehicle.

8. The system of claim 1, wherein the flange portion of the lug stud protector comprises a plurality of threaded openings.

9. The system of claim 1, wherein the tire shield is removably connected to the flange portion of the lug stud protector.

10. The system of claim 1, further comprising the wheel.

11. The system of claim 10, further comprising a tire mounted on the wheel.

12. A system, comprising:
a lug stud protector comprising a body portion and a flange portion, wherein the lug stud protector is configured to protect lug studs and corresponding lug nuts which connect a wheel to a hub of a vehicle;
a tire shield mounting adapter removably connected to the lug stud protector; and
a tire shield removably connected to the tire shield mounting adapter.

13. The system of claim 12, wherein the body portion of the lug stud protector defines cut-outs, wherein a first one of the cut-outs partially surrounds a first one of the lug studs and a first one of the corresponding lug nuts.

14. The system of claim 12, wherein the body portion of the lug stud protector is radially inward from the flange portion of the lug stud protector.

15. The system of claim 12, wherein the body portion of the lug stud protector comprises a thickness which is greater than a thickness of the flange portion of the lug stud protector.

16. The system of claim 12, wherein the body portion of the lug stud protector comprises a thickness which is greater than a thickness of the flange portion of the lug stud protector.

17. The system of claim 12, wherein the flange portion of the lug stud protector comprises a plurality of threaded openings.

18. The system of claim 12, wherein the tire shield mounting adapter defines a first plurality of openings and a second plurality of openings.

19. The system of claim 18, wherein the second plurality of openings comprise threaded openings.

20. The system of claim 12, wherein the tire shield mounting adapter extends radially outward from the lug stud protector.

21. The system of claim 12, further comprising the wheel.

22. The system of claim 21, further comprising a tire mounted on the wheel.
